(19) United States
(12) Patent Application Publication
(10) Pub. No.: US 2015/0302041 A1
(43) Pub. Date: Oct. 22, 2015

(54) MANAGEMENT OF A MESSAGE STORE

(71) Applicant: XOOLOO, Paris (FR)

(72) Inventor: Gregory Veret, Paris (FR)

(73) Assignee: XOOLOO, Paris (FR)

(21) Appl. No.: 14/440,462

(22) PCT Filed: Oct. 30, 2013
(86) PCT No.: PCT/FR2013/052599

§ 371 Date: May 4, 2015

(30) Foreign Application Priority Data
Nov. 5, 2012 (FR) 12 60481

(51) Int. Cl. G06F 17/30; H04L 12/58

(52) U.S. Cl. CPC G06F 17/30371; H04L 51/18; H04L 51/34; G06F 17/30194

(57) ABSTRACT

A method for managing a message store transmitted via a communication network. The method is implemented by a messaging server, and comprises the following steps: upon receiving a command for the expiry of a message intended for being received by a destination terminal of said message, detecting whether or not the terminal is connected to the messaging server, and according to said detection, optionally assigning an expiring message status to said message.

This invention relates to the management of a database of messages transmitted via a communication network.

More particularly, the database of messages is managed by a messaging server. The management of this database is implemented in particular in an embodiment wherein an emitting terminal of a message transmits this message to the aforementioned messaging server and the latter retransmits this message to a destination terminal according to predefined rules.

An application for the aforementioned management of a database of messages relates in particular to the situation where the emitting terminal has sent a given message in error, for example. Thus, the emitting terminal can send a request to not distribute this message, or, more particularly, to delete this message before the messaging server directs it to a destination terminal. However, between the moment when the message is sent by error and the moment when the emitting terminal sends this request, the destination terminal may have received the message and a user may have already read it.

Existing embodiments are known (in particular the email application “Outlook©”) which mention that such messages have been “recalled” by their sender without always deleting the contents of them, which in reality only attracts the attention of the user of the destination terminal to these messages.

This invention improves the situation.

To that end, it proposes to assign to such messages a status that corresponds, more generally, to an expiring message status, taking into account however the possibility for the destination terminal to have had access or not to this message. Thus, this invention proposes to detect whether or not the destination terminal is connected to the messaging server.

The invention then relates to a method for managing a database of messages, implemented by a messaging server, with the method comprising the steps of:

upon receiving a command for the expiration of a message intended for being received by a destination terminal of said message,
detecting whether or not the terminal is connected to the messaging server, and
according to said detection, assigning or not an expiring message status to the message.

Thus, according to the detection of the connection or non-connection of the destination terminal to the messaging server, particular rules can be implemented in order to manage a message to which an expiring message status has been assigned.

For example, in a possible embodiment, the message can be deleted as soon as the aforementioned status is assigned, of an expiring message. This deleting can take place with the messaging server itself for example in the case where the destination terminal has not been detected as already being connected to the server. Such an embodiment means that the destination terminal, as it is not connected, was not able to receive the message and that this message can be deleted directly with the messaging server. As such, the terminal that was the initial recipient of the message in the end does not receive the message, or any particular information concerning this message.

Thus, more generally, in the case where the destination terminal has been detected as not connected to the messaging server, the latter can manage the expiring message according to predefined rules (for example deleting it, or deleting after a delay as shall be seen further on in an embodiment, or others), without the destination terminal receiving any particular information concerning this message.

Thus, in an embodiment, if the terminal is not detected as being connected, the messaging server assigns a general expiring message status to the message.

On the other hand, if the terminal is detected as being connected, the server, in a particular embodiment, may not transmit any particular command to the destination terminal and the message retains a current status with the destination terminal. For example, if the message has a message already read status (or, on the contrary, not read) with the destination terminal, it retains a message read status (or respectively, not read).

Of course, other rules can be provided in particular in the case where the message has been sent beforehand to the destination terminal. In this case, upon receiving a command for the expiration of a message sent beforehand to the destination terminal, the messaging server can transmit to the terminal a command for assigning to said message an expiring message status with the destination terminal. In this case, the destination terminal can itself manage the expiration of the message according to its own rules (deletion, or deletion after a delay, or expiration after a delay, or simply expiration).

In an embodiment, the command for the expiration received from the emitting terminal can be accompanied by a delay parameter, and, for an expiring message:
a delay according to this parameter is applied, and
the message is assigned an expired message status after said delay.

For example, the parameter can be a predetermined duration, or a given date, or even a condition on a given event (for example, aiming to delete the message in case of defeat of a sports team), or others.

Thus, in an application where a particular message has an interest within a predetermined period (meeting during a given day and for a given duration, or a sales offer during a given period), the messaging server can transmit to the destination terminal the command to assign the “expiring” status to the message. As such, after the predetermined period, the message has an “expired” status with the terminal.

These steps of applying the delay and of assigning the “expired” status can be implemented with the destination terminal, for example. Alternatively, they can be implemented by the server itself. Indeed, in an embodiment, the server detects whether or not the destination terminal is connected and, as long as the terminal is not detected as connected, applies the delay until the expiration of the message.

Generally, it can be provided for example that a message, after the delay, has the expired message status, and that then, this message is deleted.

Thus, in the example hereinabove wherein the server implements the delay, the server can then delete the message if the destination terminal has not been detected as being connected during the delay.

In the specific case where the terminal has received the expiring or expired message, it can be provided, in an embodiment, that a message with an expired message status is retained with the destination terminal, with an indication of expiration of the message. This embodiment allows a user of the destination terminal to see for example that a meeting has taken place or that a sales promotion has taken place, at a period that is now however expired.

In an embodiment, the assigning of the “expiring” message status can be subsequent to an expiration request received from an emitting terminal of the message. For example, the deletion of a message (in a section of the “sending in progress” type) with the emitting terminal can provoke the emission of the expiration request to the server (which can be interpreted by the messaging server as a deletion request if, for example, it is not accompanied by a delay parameter, in which case the server can delete the message if the destination terminal is not detected as being connected).

In an embodiment, the detection of the connection of the terminal to the messaging server can comprise the detection of the connection of the terminal to an intermediate server (a third-party server) that can be connected to the messaging server. For example, the intermediate server can correspond to an application server of a social network (Facebook, for example).

Thus, the messaging server can repetitively interrogate the intermediate server in order to obtain information on the connection or non-connection of the destination terminal to the intermediate server and, from this, interpret any possible connection as signifying that the destination terminal is connected to the network and that it is therefore able to also connect to the messaging server.

In an alternative, the intermediate server can comprise means for connecting the destination terminal to the messaging server (for example a link to the messaging server, on a WEB page associated with the intermediate server). A usage of these means for connecting by the destination terminal can then provoke the transmission to the messaging server of information on the connection of the destination terminal to the messaging server.

In a further improved alternative, the intermediate server can comprise means for the instantaneous connection of the destination terminal to the messaging server and a connection of the destination terminal to the intermediate server provokes a connection of the destination terminal to the messaging server.

Such an embodiment can be implemented also with the emitting terminal. As such, for example, the command for the expiration of the message can be launched by the emitting terminal of the message, via the aforementioned intermediate server (for example the recalling of a sent message can be controlled on the emitting terminal, via a WEB page associated with the intermediate server, then transmitted to the messaging server). Such an embodiment can be advantageous, for example, in a context where a recipient can become aware of the message when the latter is displayed in a WEB interface (such as a Facebook® page for example), via a specific email application in the sense of the invention.

This invention also relates to a messaging server for the management of a database of messages, comprising means for the implementing of any one of the embodiments of the method hereinbefore, and in particular:
an input able to receive a command for the expiration of a message intended for being received by a destination terminal of the message,
means for detecting whether or not the terminal is connected to the messaging server, and, according to said detection, assigning to said message an expiring message status.

This invention also relates to a computer program, comprising instructions for the implementation of the method hereinabove, when this program is executed by a processor, as well as a medium for storing such a program.

This invention also relates to an intermediate server, of the aforementioned type, when such a server can assist in detecting the connection or the non-connection of the destination terminal, or participate in the transmission of requests for recalling, deleting or expiration of a message emitted by the destination terminal. It contributes as such, as an essential means, in the implementation of certain embodiments of this invention.

Other advantages and characteristics of the invention shall appear when reading the following detailed description of embodiments and when examining the corresponding drawings, wherein:

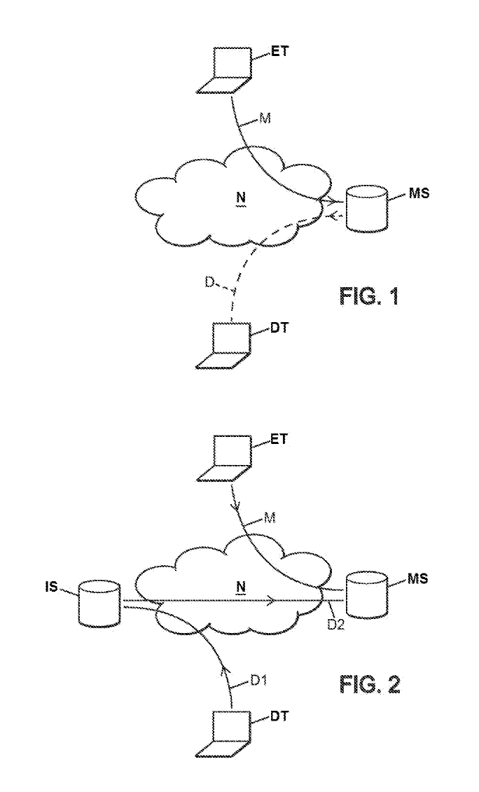

FIG. 1 shows an implementation context of this invention, calling upon a messaging server MS in the sense of the invention,

FIG. 2 shows a particular embodiment for detecting the connection or the non-connection of the destination terminal DT, and calling upon an intermediate server IS,

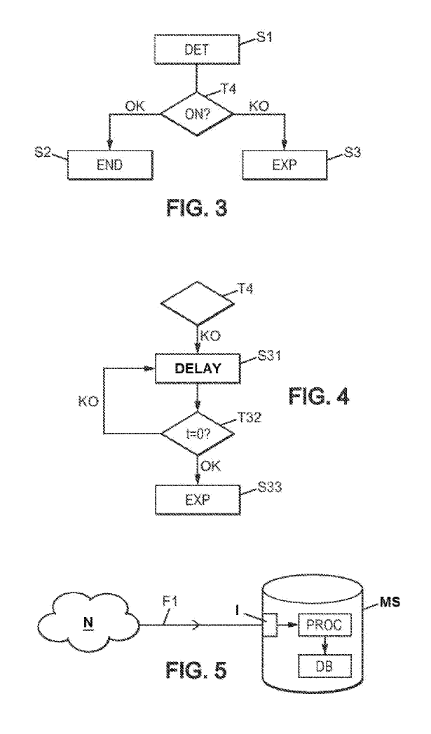

FIG. 3 diagrammatically shows the main steps that follow a detection of the connection or of the non-connection of the destination terminal DT, for the assigning of an “expired” status to a message according to this detection,

FIG. 4 shows a particular embodiment, wherein a delay is applied before the definitive expiration of the message, and

FIG. 5 diagrammatically shows an example of a messaging server MS for the implementation of the invention.

Reference is first made to FIG. 1 wherein an emitting terminal ET of a message M, a messaging server MS and a destination terminal of a message M, can communicate together via a communication network N (such as, for example, Internet). More particularly, the messaging server MS centralizes the exchanges of messages between the various terminals and manages a database of messages M, for this purpose. In a possible application context of this invention, the emitting terminal ET requires from the messaging server MS that the message M, intended for the destination terminal DT, has an expired message status.

For example, the emitting terminal ET can desire that the message M not be read, in the end, by the destination terminal DT (the message M having been sent in error, for example). In another embodiment, it can simply be provided that the message M has an expiring message status, or an expired message status, although it has been received by the destination terminal DT.

In terms of the invention, the assigning of such a status (or even the deleting of the message M without it being transmitted to the terminal DT) depends on the state of the connection or non-connection of the destination terminal DT to the messaging server MS.

FIG. 5 for this purpose shows a messaging server MS comprising for example an input I to receive an expiration request for a given message, sent beforehand by an emitting terminal ET. The server furthermore has means, such as a processor PROC and a memory storing the data of a database of messages DB, in order to find the message and assign it an expiration status (according to the detection of a connection or non-connection of the destination terminal). The aforementioned detection of the connection or non-connection can be carried out with the messaging server, for example by the recognition of an IP address of the destination terminal, or of a connection identifier, or others. As such, the processor PROC and/or the memory DB can still be used.

However, the notion of a connection or non-connection of the destination terminal to the messaging server must be interpreted in the broad sense. It is sought in particular to detect a possibility of the connection or non-connection of the terminal to the messaging server. For example, if there is success in detecting that the destination terminal is connected to the communication network N, then the destination terminal is simply able to connect to the messaging server and it can be decided whether or not to implement the assigning of a message expiration status, based on this information only. As such, if the messaging server does not have any means for detecting the connection of the destination terminal to the communication network N, use is made of other servers to which the terminal can be connected and which can transmit to the messaging server this information of the connection of the terminal. By way of example, use can as such be made of an intermediate server, for example an application server of a social network (hosting an account or a Facebook® page for example), capable of notifying the messaging server of a connection of the terminal to this intermediate server.

FIG. 2 shows a corresponding embodiment. Here, the terminal DT connects to the intermediate server IS (arrow D1) and this connection information is transmitted to the messaging server (arrow D2). In an embodiment, the connection of the terminal to the intermediate server can automatically trigger the connection of the terminal to the messaging server. For example, the number of messages received with the messaging server, for a given Facebook account, can be displayed on an individual Facebook page, associated with this given account. Likewise, the user of the emitting terminal can have an account with the same intermediate server, in particular in order to launch an expiration request for the message already sent (or simply, connect directly to the messaging server in order to request an expiration of the message).

Reference is now made to FIGS. 3 and 4 in order to describe an embodiment of the method in terms of this invention. These figures show flowcharts corresponding to general algorithms of a computer program in the sense of this invention, in order to assign an expiration status to a message, according to the detection of a connection of the destination terminal of this message.

(In reference to FIG. 3, following the step S1 of detection and the test T4 of the connection or non-connection of this terminal, in an embodiment, if the terminal is already connected (arrow OK at the output of the test T4), no action is carried out in relation to the message probably already received by the destination terminal the method stops at the ending step S2. As such, the message can naturally retain its current status with the destination terminal. On the other hand, if the terminal is not connected (arrow KO at the output of the test T4), a message expiration status is assigned in the step S3.)

In an alternative, it can be decided to transmit to the destination terminal, in the step S2, an expiration command concerning a message that has already been transmitted, in such a way that the destination terminal manages on its side the expiration of this message.

Moreover, the assigning of the expiration status in the step S3, can consist simply in deleting the message, without it being transmitted to the non-connected destination terminal.

In another alternative, shown in FIG. 4, a delay can be provided in the step S31 before assigning any status to the message. As such, a time value counter t can be decremented to zero, as long as this value of zero is not reached (arrow KO at the output of the test T32). On the other hand, if the value of zero is reached (arrow OK at the output of the test T32), the expired message status is assigned in the step S33. This expired message status can simply correspond to a deleting of the message, without communication to the destination terminal. In an alternative, the message can be transmitted to the destination terminal later and can appear as being expired, with a suitable presentation (for example in italic characters, or others).

Of course, this invention is not limited to the embodiment described hereinabove by way of example; it extends to other alternatives.

Thus, an embodiment has been described hereinabove wherein, if the destination terminal is not connected, the expiration status can then be assigned to the message. In an alternative however, this status, on the contrary can be assigned if the terminal is connected in order to indicate to its user for example that an event associated with this message is no longer in progress and, for example, simply delete this message with the messaging server if the destination terminal is not connected.

Moreover, the term “expiring message status” generally means the fact that a message must:
have an expired message status after a delay,
or directly have an expired message status, without a delay,
or be deleted after a delay,
or be deleted directly, without a delay,

and this, as shown in the various embodiments hereinabove.

Moreover, the expiration status assigned later to a message may not be necessarily linked to a delay, but can depend on other conditions such as for example the connection or the disconnection of the destination terminal, in particular of a WEB page. For example, in an embodiment, a message received by a terminal while participating in a forum on a WEB site can become “expired” after the terminal has disconnected from the forum.

1. A method for managing a database of messages, implemented by a messaging server, wherein the method comprises the steps:
upon receiving a command for the expiration of a message intended for being received by a destination terminal of said message,
detecting whether or not the terminal is connected to the messaging server, and
according to said detection, assigning or not an expiring message status to said message.

2. The method according to claim 1, wherein, if the terminal is detected as not connected, the messaging server assigns an expiring message status to the message.

3. The method according to claim 1, wherein, if the terminal is detected as connected, the server does not transmit any command to the destination terminal and the message retains a current status with the destination terminal.

4. The method according to claim 1, wherein, the message having been sent beforehand to the destination terminal, the messaging server transmits to the terminal a command for assigning to said message an expiring message status with the destination terminal.

5. The method according to claim 1, wherein the command for the expiration is accompanied by a delay parameter, and, for an expiring message:
a delay is applied according to said parameter, and
an expired message status is assigned to the message after said delay.

6. The method according to claim 5, wherein a message with the expired message status is deleted.

7. The method according to claim 5, wherein a message with an expired message status is retained with the destination terminal, with an indication of the expiration of the message.

8. The method according to claims claim 1, wherein the message is deleted as soon as the expiring message status is assigned.

9. The method according to claim 1, wherein the assigning of the expiring message status is subsequent to an expiration request received from an emitting terminal of the message.

10. The method according to claim 9, wherein the deletion of a message with the emitting terminal provokes the emission of the expiration request to the server.

11. The method according to claim 1, wherein the detecting of the connection of the terminal to the messaging server comprises the detecting of the connection of the terminal to an intermediate server connected to the messaging server.

12. The method according to claim 11, wherein the messaging server regularly interrogates the intermediate server in order to obtain information on the connection or non-connection of the destination terminal to the intermediate server.

13. The method according to claim 11, wherein the intermediate server comprises means for the instantaneous connection of the destination terminal to the messaging server and a connection of the destination terminal to the intermediate server provokes a connection of the destination terminal to the messaging server.

14. An email server for the management of a database of messages, comprising:
an input able to receive a command for the expiration of a message intended for being received by a destination terminal of the message,
means in order to detect whether or not the terminal is connected to the messaging server, and, according to said detection, assigning to said message an expiring message status.

15. A non-transitory computer readable program product, with a program stored thereon, wherein the program comprises instructions for the implementation of the method according to claim 1, when this program is executed by a processor.
